(19) United States
(12) Patent Application Publication
(10) Pub. No.: US 2026/0099733 A1
(43) Pub. Date: Apr. 9, 2026

(54) SYSTEMS AND METHODS FOR TRUSTABLE CHAT NAME SERVICE

(71) Applicant: Verizon Patent and Licensing Inc., Basking Ridge, NJ (US)

(72) Inventors: Cheul Shim, River Vale, NJ (US); Thierry R. Sender, New York, NY (US); David Strumwasser, Somerville, NJ (US)

(21) Appl. No.: 18/910,419

(22) Filed: Oct. 9, 2024

(51) Int. Cl. G06N 5/04

(52) U.S. Cl. CPC G06N 5/04

(57) ABSTRACT

Systems and methods described herein enable clients to chat with various artificial intelligence (AI)-based applications and large language model (LLM) services through a single user interface with assured privacy and security. A network device stores, in a memory, service level information of multiple external AI services. The network device receives a natural language request from a client device and directs a prompt message to a chat-name service (CNS) system. The prompt message includes the natural language request. The network device converts the natural language request into at least one sequent chain of services to be performed by a target service of the multiple external AI services and send a service call to the target service based on the at least one sequent chain of services. The network device forwards a response from the target service to the client device.

### BACKGROUND

Generative artificial intelligence (AI) systems perform tasks and generate new content based on user input applied to large datasets. The quality of the user input, along with the appropriate dataset selection, can significantly affect the performance and utility of generative AI models.

### BRIEF DESCRIPTION OF THE DRAWINGS

FIG. 1 is a diagram illustrating concepts described herein;

FIG. 2 is a diagram illustrating a network environment in which an embodiment of a trustable chat name service (CNS) may be implemented;

FIG. 3 is a diagram illustrating exemplary components of a device that may correspond to one or more of the devices illustrated herein;

FIGS. 4A and 4B are block diagrams illustrating communications among exemplary logical components of a trustable CNS;

FIG. 5 is an illustrations of a CNS query, according to an implementation;

FIG. 6 is an illustration of a customer CNS database, according to an implementation;

FIG. 7 is a illustration of a CNS response, according to an implementation;

FIGS. 8-10B are signal flow diagrams illustrating different use cases of the trustable CNS, according to different implementations; and

FIG. 11 is a flow diagram illustrating a process of using a trustable CNS, according to an implementation described herein.

### DETAILED DESCRIPTION

The following detailed description refers to the accompanying drawings. The same reference numbers in different drawings may identify the same or similar elements. Also, the following detailed description does not limit the invention.

Systems and methods described herein enable clients to “chat” with various artificial intelligence (AI)-based applications and large language model (LLM) services through a single user interface with an assured privacy and security. The systems and methods, referred to herein as a chat name service (CNS) or trustable CNS, may receive service-agnostic natural language input from a client, interpret the input, select appropriate target applications and/or LLM services to address the input, and assign a sequent chain of services to be performed by the target applications and/or LLM services.

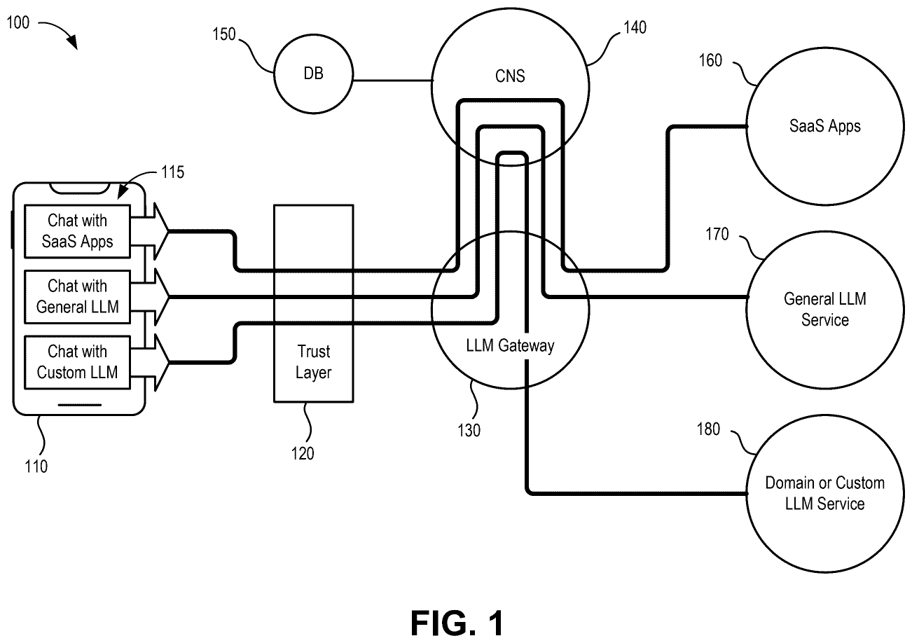

FIG. 1 illustrates concepts described herein. As shown in FIG. 1, a client device 110 (e.g., a smartphone, tablet, computer, wearable device, etc.) may include a client interface 115 to receive user input for natural language inquiries. Client interface 115 may be included in web browsers or mobile apps, or embedded in software-as-a-service (SaaS) applications accessed on client device 110.

A trust layer 120 may be a responsible generative AI/LLM service that enables data security and privacy protection between the client device 110 and a LLM gateway 130. The LLM gateway 130 may be a web framework interacting with client device 110 (e.g., via trust layer 120), a chat name service (CNS) server 140, and external applications and LLM services 160, 170, and/or 180.

CNS server 140 may be a resolver that converts, for example, natural language user input into a structured list of service chains by referencing a database (e.g., database 150). The database (DB) 150 maintains service level information for applications and LLM services by authorization scope. External SaaS applications and LLM services 160, which may include various SaaS apps 160, general LLM services 170, and/or domain or custom LLM services 180, may be the target services used to handle the user request. SaaS apps 160 may include services of trusted connection partners supported by the CNS server. SaaS apps 160 may include, for example, email applications, workplace productivity applications, customer relationship management applications, etc. General LLM services 170 may include open generative AI models. Domain or custom LLM services 180 may include domain-specific or customized LLM models, such as topic-focused models (e.g., law, finance, business, etc.), enterprise-specific models, etc.

According to implementations described herein, user inputs may be provided to client interface 115 by natural-language chat in a text and/or speech format. Client device 110 may send the user input to LLM gateway 130 via trust layer 120 providing security and privacy protection.

LLM gateway 130 may send a query with the user input to CNS server 140, which converts the natural-language input message into a structured list of service chains with the applicable External SaaS applications and LLM services 160-180. For example, CNS server 140 may identify one or more external services best-suited to address the user's natural-language query. LLM gateway 130 may use the structured list to interact with the applicable External SaaS applications and LLM services 160 and obtain the requested result. LLM gateway 130 may then return the output result to client device 110 for presentation to the user (e.g., who initiated the original query). Thus, the trustable CNS may direct generic natural language chat input to an AI service best-suited to provide the requested information.

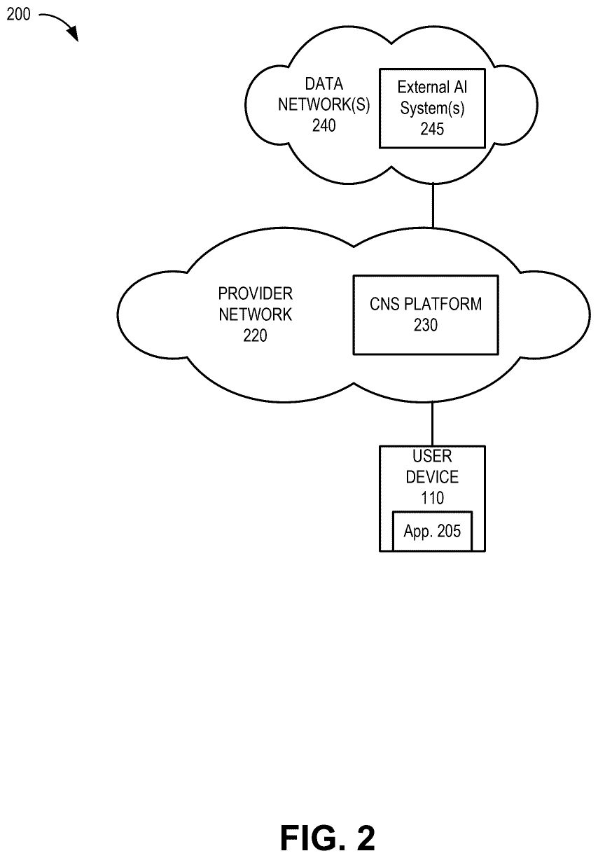

FIG. 2 illustrates an example network environment in which the trustable CNS described herein may be implemented. As shown in FIG. 2, environment 200 may include client device 110, a provider network 220 with a CNS platform 230, and one or more data networks 240 that include external AI systems 245.

Client device 110 may include a portable communication device (e.g., a mobile phone, a smartphone, a tablet device, a wearable device, and/or another type of wireless device); a laptop computer or another type of portable computer; a desktop computer; a media playing device; a portable gaming system; and/or any other type of computer device with communication and output capabilities (e.g., an infotainment system in a vehicle, etc.). In one implementation, client device 110 may be provided with one or more applications 205 (e.g., a browser application, an app designated for a specific purpose, etc.) that include a user interface (UI), such as a graphical UI (GUI) that can be manipulated via input mechanisms of client device 110. For example, according to implementations described herein, applications 205 may include or access client interface 115 to receive natural language input from a user and present eventual responses.

Provider network 220 may include network devices, computing devices, and other equipment to provide services, including services for customers with client devices 110. For example, devices in provider network 220 may supply network services, data services, and or communication services to client devices 110. Provider network 220 may include, for example, one or more private Internet Protocol (IP) networks that use a private IP address space. In other implementations, provider network 220 may include a local area network (LAN), an intranet, a private wide area network (WAN), a public land mobile network (PLMN), and/or another network.

As illustrated in FIG. 2, provider network 220 may include CNS platform 230. CNS platform 230 may include one or more computing devices or network devices with AI and/or machine learning (ML) logic to provide the trustable CNS. For example, CNS platform 230 may include one or more of trust layer 120, LLM gateway 130, CNS server 140, and database 150. As described herein, CNS platform 230 may allow clients to chat with various applications and LLM services through a single user interface with assured privacy and security.

Data network 240 may include a data network, such as a packet data network. A particular data network 240 may be associated with an Access Point Name (APN), and a user device, such as client device 110 or CNS platform 230, may request a connection to a particular data network 240 using the APN. Data network 240 may include, and/or be connected to and enable communication with, a LAN, a WAN, a metropolitan area network (MAN), an autonomous system (AS) on the Internet, an optical network, a cable television network, a satellite network, a wireless network (e.g., a Fifth Generation (5G) system, a Sixth Generation (6G) system, and/or a Long-Term Evolution (LTE) network), an ad hoc network, a telephone network (e.g., the Public Switched Telephone Network (PSTN) or a cellular network), an intranet, or a combination of networks. In some implementations, one or more network functions of data network 240 may be deployed locally (e.g., in an edge network). Data network 240 may include an application server (also referred to as application), such as external AI systems 245. An application may provide services requested by CNS platform 230, for example, and may establish communication sessions with CNS platform 230.

External AI systems 245 may include one or more computing devices, such as a server device, a computer device, or a collection of server/computer devices. External AI system 245 may include one or more of SaaS applications 160, general LLM services 170, and domain or custom LLM services 180 described above. For example, external AI system 245 (e.g., when corresponding to a general LLM service 170) may be an AI-based third-party vendor service, (such as CHATGPT, CLAUDE AI, GOOGLE BARD AI, IBM WATSON, etc.), capable of processing input from CNS platform 230. As another example, external AI system 245 (e.g., when corresponding to a SaaS apps 160) may be an email service (such as GMAIL), a workplace productivity application (such as WORKDAY), etc. As still another example, external AI system 245 (e.g., when corresponding to a custom LLM service 180) may be an enterprise-specific LLM (such as a corporate knowledge base) or a field-specific LLM (such as a dedicated legal, financial, or medical LLM).

External AI systems 245 may analyze the input from CNS platform 230 and detect one or more predicted best actions associated with the input from CNS platform 230. External AI system 245 may provide the predicted best answer, action, and/or analysis to CNS platform 230. Additionally, or alternatively, external AI system 245 may determine that no actions are available for the given input, and notify CNS platform 230.

Environment 200 provides one illustrative configuration for implementing CNS platform 230 to provide the trustable CNS. In other implementations, CNS platform 230 may be configured as a distributed component, partly executed within client device 110 and provider network 220, or fully executed within another network.

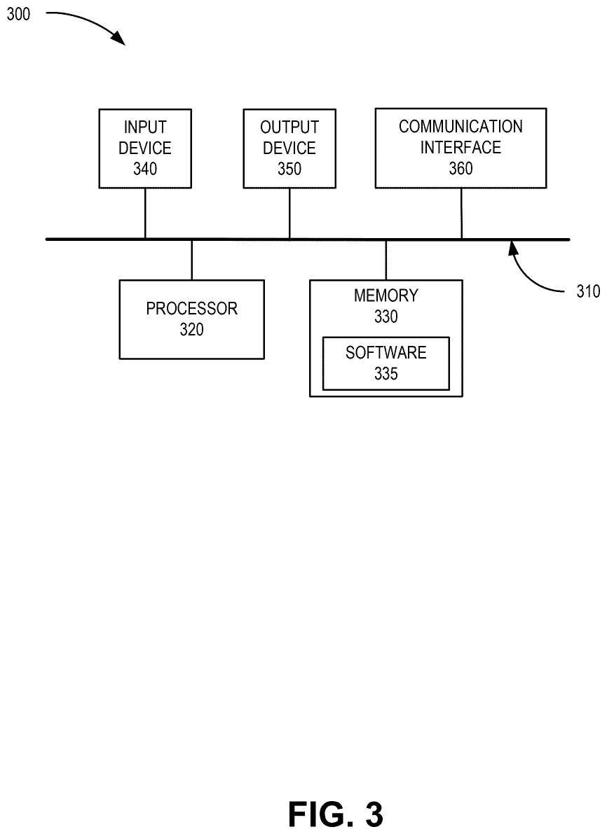

FIG. 3 is a diagram illustrating exemplary components of device 300 according to an implementation described herein. Client device 110, trust layer 120, LLM gateway 130, SaaS Apps 160, general LLM services 170, domain or custom LLM services 190, CNS platform 230, external AI system 245, and other devices in provider network 220 or data network 240 may each include one or more devices 300. As shown in FIG. 3, device 300 may include a bus 310, a processor 320, a memory 330 with software 335, an input device 340, an output device 350, and a communication interface 360.

Bus 310 may include a path that permits communication among the components of device 300. Processor 320 may include any type of single-core processor, multi-core processor, microprocessor, latch-based processor, and/or processing logic (or families of processors, microprocessors, and/or processing logics) that interprets and executes instructions. For example, processor 320 may include one or more Central Processing Units (CPUs) and/or one or more Graphics Processing Units (GPU). In other embodiments, processor 320 may include an application-specific integrated circuit (ASIC), a field-programmable gate array (FPGA), and/or another type of integrated circuit or processing logic. Processor 320 may control operation of device 300 and its components.

Memory 330 may include any type of dynamic storage device that may store information and/or instructions, for execution by processor 320, and/or any type of non-volatile storage device that may store information for use by processor 320. For example, memory 330 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Software 335 includes an application or a program that provides a function and/or a process. Software 335 may also include firmware, middleware, microcode, hardware description language (HDL), and/or other form of instruction. By way of example, with respect CNS platform 230, functional elements of CNS platform 230 may include software 335 to perform tasks as described herein.

Input device 340 may allow an operator to input information into device 300 and/or to collect information from the environment using one or more sensors. Input device 340 may include, for example, buttons (e.g., a keyboard, keys of a keypad, control buttons, etc.), a voice recognition device/system, a mouse, a pen, a joystick, a tracking pad, a stylus, a remote control, a microphone or another audio capture device, an image and/or video capture device (e.g., a camera), a touch-screen display, a light sensor, a gyroscope, an accelerometer, a proximity sensor, a temperature sensor, a barometer, a compass, a health sensor (e.g., pulse rate monitor, etc.), and/or another type of input device. In some implementations, device 300 may be managed remotely and may not include input device 340.

Output device 350 may output information to an operator of device 300 and/or to control device 300 and/or the environment using one or more actuators. Output device 350 may include a display, a printer, a speaker, an actuator to cause device 300 to vibrate, a motor to cause part of device 300 to move, a lock device, and/or another type of output device. For example, device 300 may include a display, which may include a liquid-crystal display (LCD), a light emitting diode (LED) display, an organic LED (OLED) display, an electrophoretic (e.g., electronic ink) display, and/or another type of display device for displaying content to a user. In some implementations, device 300 may be managed remotely and may not include output device 350.

Communication interface 360 may include a transceiver that enables device 300 to communicate with other devices and/or systems via wireless communications (e.g., radio frequency (RF), infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 360 may include a transmitter that converts baseband signals to RF signals and/or a receiver that converts RF signals to baseband signals. Communication interface 360 may be coupled to an antenna for transmitting and receiving RF signals. For example, if device 300 is included in client device 110, communication interface 360 may include an antenna assembly that includes one or more antennas to transmit and/or receive RF signals.

Communication interface 360 may include a logical component that includes input and/or output ports, input and/or output systems, and/or other input and output components that facilitate the transmission of data to other devices. For example, communication interface 360 may include a network interface card (e.g., Ethernet card) for wired communications and/or a wireless network interface (e.g., a Wi-Fi™) card for wireless communications. Communication interface 360 may also include a universal serial bus (USB) port for communications over a cable, a Bluetooth™ wireless interface or an interface for another type of short range (e.g., less than 100 meters) wireless communication method, a radio-frequency identification (RFID) interface, a near-field communications (NFC) wireless interface, a Global Positioning System (GPS) receiver to obtain location information from GPS satellites, an optical transceiver, and/or any other type of interface that converts data from one form to another form.

As will be described in detail below, device 300 may perform certain operations relating to graphical network design and configuration tools. Device 300 may perform these operations in response to processor 320 executing software instructions (e.g., software 335) contained in a computer-readable storage medium, such as memory 330. A computer-readable storage medium may be defined as a non-transitory memory device. A memory device may be implemented within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of device 300, in other implementations, device 300 may include fewer components, different components, additional components, or differently arranged components than depicted in FIG. 3. Additionally, or alternatively, one or more components of device 300 may perform one or more tasks described as being performed by one or more other components of device 300.

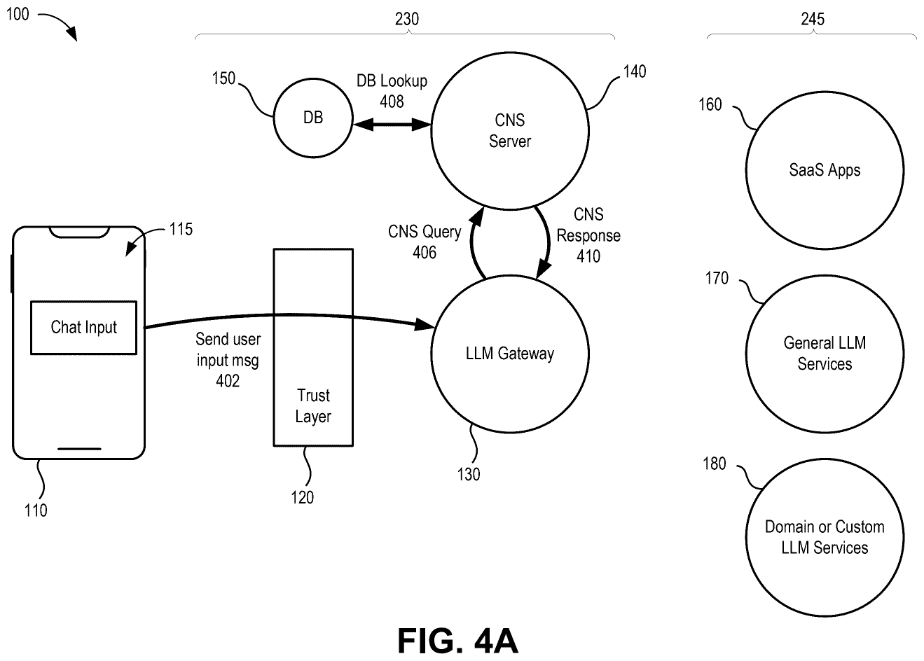

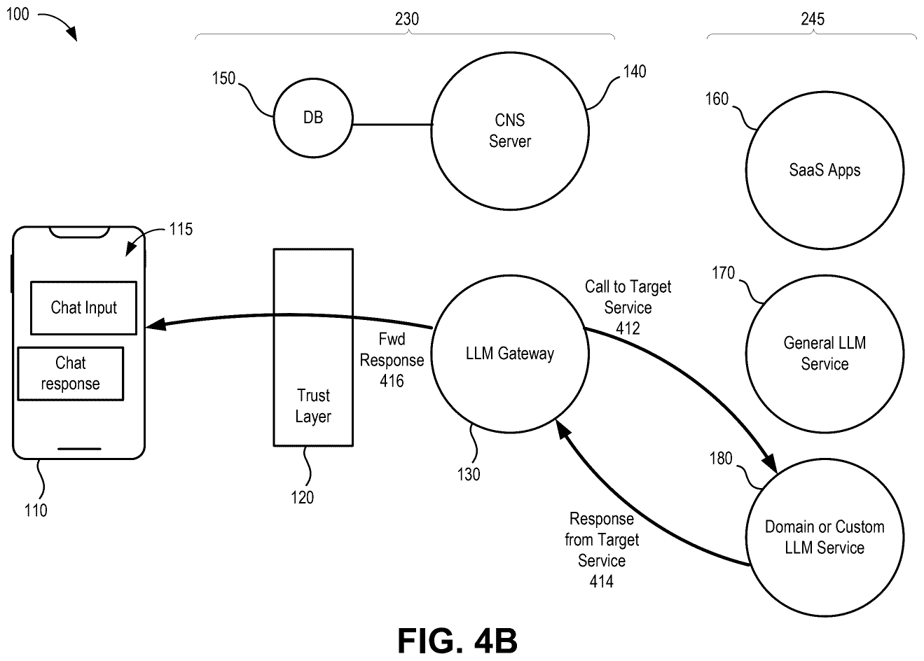

FIGS. 4A and 4B are diagrams illustrating communications among exemplary logical components of CNS platform 230, according to an implementation. CNS platform 230 may be a standalone system or distributed within one or multiple devices of environment 200. The logical components of CNS platform 230 may be implemented, for example, via processor 320 executing instructions from memory 330. Alternatively, some or all of the logical components included in CNS platform 230 may be implemented via hard-wired circuitry. As shown in FIG. 4A, CNS platform 230 may include trust layer 120, LLM gateway 130, CNS server 140, and database 150. Logical components of CNS platform 230 may interface with other devices, such as client device 110 and different external AI systems 245.

Trust layer 120 may include one or more network devices that address security, vulnerability, privacy and ethical bias for natural language inquires. For example, trust layer 120 may apply network-layer access controls using an access control list or firewall settings based on a client device identifier (ID), network address, or subscription information. Trust layer 120 may use an authorization key or other access control techniques to ensure trusted client devices 110 have access to CNS platform 230. Trust layer 120 may also ensure privacy and reduce ethical bias. For example, in one aspect, trust layer 120 may perform data masking to protect sensitive information. In another aspect, trust layer 120 may protect enterprise intellectual property, such as business data, source codes, etc., by restricting access/distribution to registered users. In still other aspects, trust layer 120 may perform ethical filtering based on bias detection, consent control, transparency (e.g., data detoxication).

LLM gateway 130 may include one or more network devices that receives a client prompt message (e.g., from client device 110) and requests resolution of a chain of the service names (e.g., from CNS server 140) based on the client prompt message. In one implementation LLM gateway 130 may be implemented as an instance in a web framework. As described further herein, LLM gateway 130 may create a new LLM prompt message along with a natural language user input message and then send the new LLM prompt message to CNS server 140 as a CNS query message. LLM gateway 130 may interact with target applications (e.g., SaaS apps 160) and/or LLM services (e.g., services 170, 180) as represented in the response from the CNS server 140. LLM gateway 130 may return the output from the last service in the service chain to client device 110 as a response to the original user message.

CNS server 140 may include one or more network devices that provide a fine-tuned LLM service to resolve the user input message into a chain of the services and the relevant pairs of commands and parameters. In one implementation, CNS server 140 may be a lightweight version of a LLM service fine-tuned to handle CNS query messages from LLM gateway 130. CNS server 140 may interpret context in the user input message in a series of the target applications and LLM service by conducting a lookup in the CNS database 150. CNS server 140 may access the customer layer of database 150 with the authorization key assigned to an individual customer. Next, CNS server 140 may identify the relevant commands and parameters, such as an application's application programming interface (API) call and parameter, and the way to access LLM services. CNS server 140 may identify the way to handle the outputs from the target applications and LLM services. CNS server 140 may formulate the commands into a structured format and return the structured format to LLM gateway 130. In one implementation, CNS server 140 and LLM gateway 130 may use protected access via an authorized key and a mutually secure communication channel between them.

CNS database 150 may include a database, database server, or network device that stores the information of all registered apps (e.g., SaaS apps 160) and LLM services (e.g., services 170, 180). A customer database may be a subset of the overall CNS database 150. Database 150 may include, for example, an app/service name, a unique ID, a domain category, a status, a vendor/provider, a type, statistics on the use and popularity, and other information. In one implementation, database 150 may have a hierarchy defined by authorization scope and roles. For example, database 150 may include a top global master DB, a second layer DB for enterprise, a third layer for organization, a fourth layer for team/group, a fifth layer for an end user/customer/client, and so on. FIG. 6, described further below, provides an illustration of a portion of CNS database 150 along with a customer database subset.

Client device 110 may interface with LLM gateway 130 through trust layer 120 to submit user input messages (e.g., natural language queries). Client device 110 may include client interface 115 to receive user input for natural language inquiries for both text and speech. The user input message may be sent to LLM gateway 130 with an authorized key over a secure channel established via trust layer 120. The input message can be sent through a web browser, client application software, or a SaaS application, for example.

External AI systems 245 may include SaaS applications 160, general LLM services 170, and custom LLM services 180. External AI systems 245 may be accessed via API calls with an authorization key. The authorization API key is securely maintained by LLM gateway 130 and used when accessing the application via an API call (for example, a REST or SOAP API call). SaaS applications 160, general LLM services 170, and domain or custom LLM services 180 may be onboarded with CNS platform 230. After successful onboarding of a new application/service, the new application/service may be registered into CNS database 150. By the client's subscription to the application, the client device 110 can then use the new service/application through CNS platform 230.

SaaS applications 160 may include business/enterprise applications and SaaS applications that may be provided by third parties. Examples of SaaS applications include GMAIL, SLACK, WORKDAY, SALESFORCE, etc. General LLM services 170 may include general models by large scale LLM providers, such as OPEN AI, META, PALM, ANTHROPIC, LLAMA, etc. Domain/Custom LLM services 180 may include domain-specific LLM services (e.g., legal, finance, healthcare, engineering, human resources, etc.) and/or fine-tuned custom LLM services.

As shown in FIG. 4A, a user may use client interface 115 on client device 110 to generate and send a user input message 402. User input message 402 may be a natural-language input message from a user interface like web browser or embedded application. User input message 402 may be service agnostic (e.g., not directed to or identifying any particular one of external AI systems 245). After authentication through trust layer 120, input message 402 may be received at LLM gateway 130.

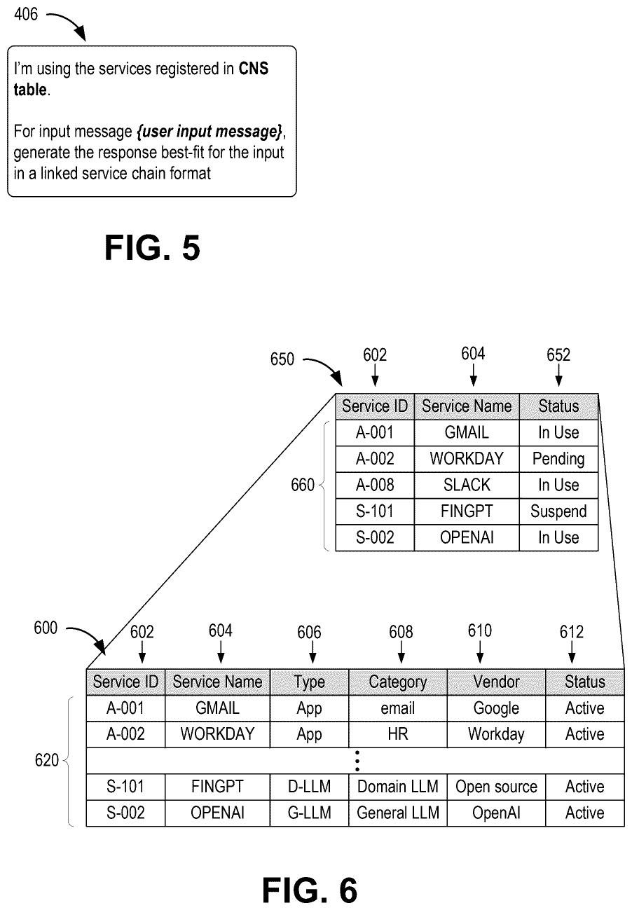

LLM gateway 130 may generate a CNS query message 406 based on user input message 402. CNS query message 406 may be a new kind of prompt message structuring an instruction that can be interpreted and understood by a CNS LLM (e.g., in CNS server 140) along with user input written in a natural-language format such as text or speech-to-text. CNS query message 406 may, for example, include an introduction phrase to activate CNS server 140. FIG. 5 illustrates a sample format for CNS query message 406.

CNS server 140 may receive CNS query message 406 and conduct a lookup 408 with database 150 to determine the authorization scope for the customer (e.g., what services/applications a user is subscribed to and/or permitted to access) based on an authorization key. FIG. 6 illustrates a customer database 650 as a subset of a global CNS database 600. Global CNS database 600 may include all registered services and applications accessible to the CNS service, such as all SaaS applications 160, all general LLM services 170, and all domain or custom LLM services 180. Customer database 650 may include a subset of services from global CNS database 600 to which a particular customer (e.g., a user of client device 110) may have subscriptions and/or access.

As shown in FIG. 6, global database 600 may include a service ID field 602, a service name field 604, a type field 606, a category field 608, a vendor field 610, and a status field 612. A variety of registered services may be listed as records 620 in fields 602-612. Service ID field 602 may include a unique identifier for a record of a service registered with the CNS system (e.g., A-001, A-002, etc.). Service name field 604 may include a product or service name for the service (e.g., GMAIL, WORKDAY, etc.). Type field 606 may include a type of the service, such as an app (e.g., one of SaaS applications 160), a general LLM (e.g., one of general LLM services 170), or a domain LLM (e.g., one of domain or custom LLM services 180). Category field 608 may include a category indication for the service (e.g., a type of app, such as email, human resources, etc.) Vendor field 610 may include a vendor for the service (e.g., GOOGLE, WORKDAY, etc.). Status field 612 may include an overall status for the service, such active/available, unavailable, etc.

Customer database 650 may include service ID field 602, service name field 604, a status field 652, and multiple records 660. Customer database 650 may correspond to a particular customer's scope of access to services in global database 600. For example, in the illustration of FIG. 6, customer database 650 may indicate in status field 652 a status of a particular service in relation to a particular customer (e.g., a user of client device 110). Thus, status field 652 may include a customer status for a service, such in use, pending, suspended, etc.

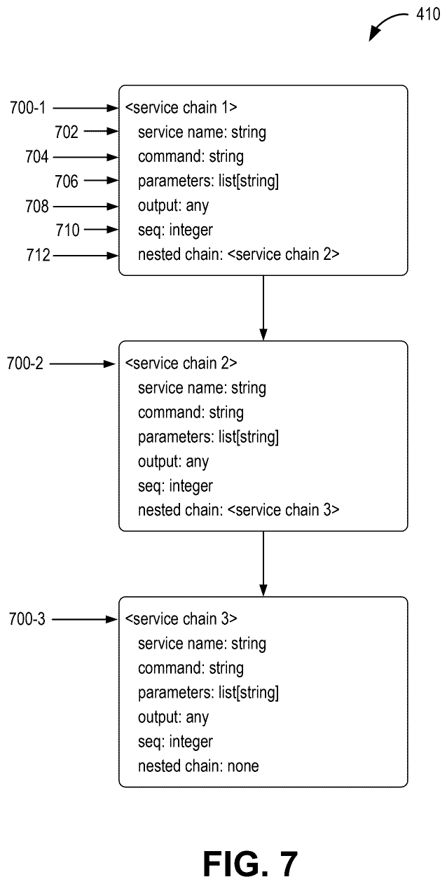

Returning to FIG. 4A, after conducting lookup 408, CHS server 140 may generate a CNS response 410. CNS response 410 may include, for example, a chain of one or more services to provide a response to the original natural language inquiry (e.g., message 402). FIG. 7 provides an example format for CNS response 410. CNS response 410 may be structured in the form of a sequent chain of apps and/or LLM services (collectively referred to as a “sequent chain of services”) best-fit for the context expressed in the CNS query message 406 based on the authorization scope allowed for the user. In one implementation, CNS response 410 may be provided in a concatenated format that includes a registered name of the target service, commands, and parameters for each link in the sequent chain of services.

As shown in FIG. 7, a response may include a service chain link 700-1 that includes a service name field 702, a command field 704, a parameters field 706, an output field 708, a sequence field 710, and a nested chain field 712. Service name field 702 may identify the name of a service, such as a certain service from one of SaaS applications 160, general LLM services 170, or domain or custom LLM services 180. Command field 704 may identify a command to provide to the identified service, such as an API call to access a service/application from a third-party provider. The command may include, for example, a first step in a multistep process to resolve the original natural language inquiry (e.g., message 402), such as to retrieve a certain dataset for subsequent analysis. Parameters field 706 may include parameters to support the command, such a user ID, maximum number of results, file names, etc. Output field 708 may include, for example, an output format or type. Sequence field 710, if necessary, may include an integer value indicating an order of service chain link 700 in a sequence of multiple service chains. Nested chain field 712 may identify another service chain (e.g., “service chain 2”) to be performed after service chain link 700 is completed.

Returning to FIG. 4A, LLM gateway 130 may receive CNS response 410 and interact with the target applications and LLM services as represented in CNS response 410. For example, LLM gateway 130 may apply CNS response 410 to submit an API call to a target service (e.g., a service under one of SaaS applications 160, general LLM services 170, and domain or custom LLM services 180). As shown in FIG. 4B, LLM gateway 130 may submit a call 412 that is consistent with commands 704/parameters 706 of a first service chain link 700-1 of CNS response 410. In the example of FIG. 4B, call 412 may be directed to one of domain or custom LLM services 180.

The domain or custom LLM services 180 may receive call 412 and provide a response 414 consistent with the purpose and scope of the custom LLM model. If applicable, upon receiving response 414, LLM gateway 130 may submit another call (not shown) that is consistent, for example, with commands 704/parameters 706 of a second service chain link 700-2 of CNS response 410. The second service call, as directed in service chain link 700-2, may be to another of domain or custom LLM services 180, or to a service in one of SaaS applications 160 or general LLM services 170.

If CNS response 410 includes only one service chain link 700, as in the example of FIG. 4B, or after all the links 700 of the service chain have been completed, LLM gateway 130 may forward response 414 to client device 110 via trust layer 120, as indicated by reference 416. The response may be presented to the user, for example, via client interface 115.

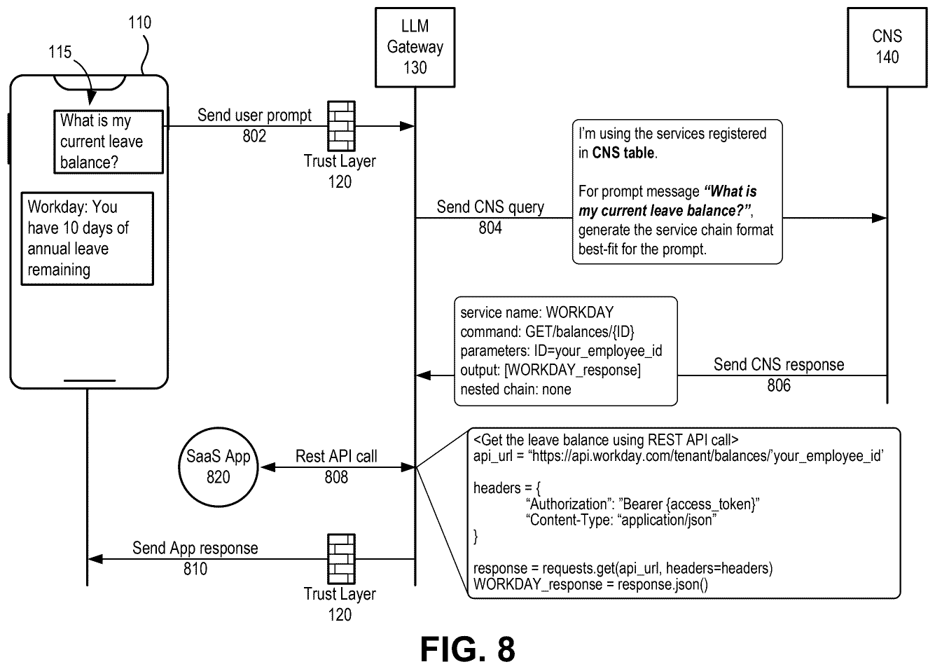

FIGS. 8-10B illustrate communications for different use cases for the trustable CNS. For example, FIG. 8 illustrates a CNS simple query for a SaaS application. As shown in FIG. 8, a user may input (e.g., chat, text, etc.) a prompt (“What is my leave balance?”) to client interface 115, and client device 110 may send a user prompt 802 via trust layer 120 to LLM gateway 130. LLM gateway 130 may generate a CNS query 804 and send the CNS query 804 to CNS server 140.

CNS server 140 may receive CNS query 804 and generate a CNS response 806 including at least one sequent chain of services. CNS response 806 may be compiled based on the scope of access indicated in a customer CNS database for the user (e.g., database 650). CNS response 806 may include an appropriate service (“WORKDAY”) with commands and parameters for generating a request. CNS server 140 may send, and LLM gateway 130 may receive, CNS response 806. LLM gateway 130 may provide to SaaS app 820 an API call 808 (e.g., a REST API call) as described in CNS response 806 and illustrated in FIG. 8. SaaS app 820 may correspond, for example, to one of the applications in registered SaaS apps 160. Upon receiving a response from SaaS app 820, LLM gateway 130 may forward the response 810 to client device 110 for presentation on client interface 115 (e.g., “You have 10 days of annual leave remaining.”).

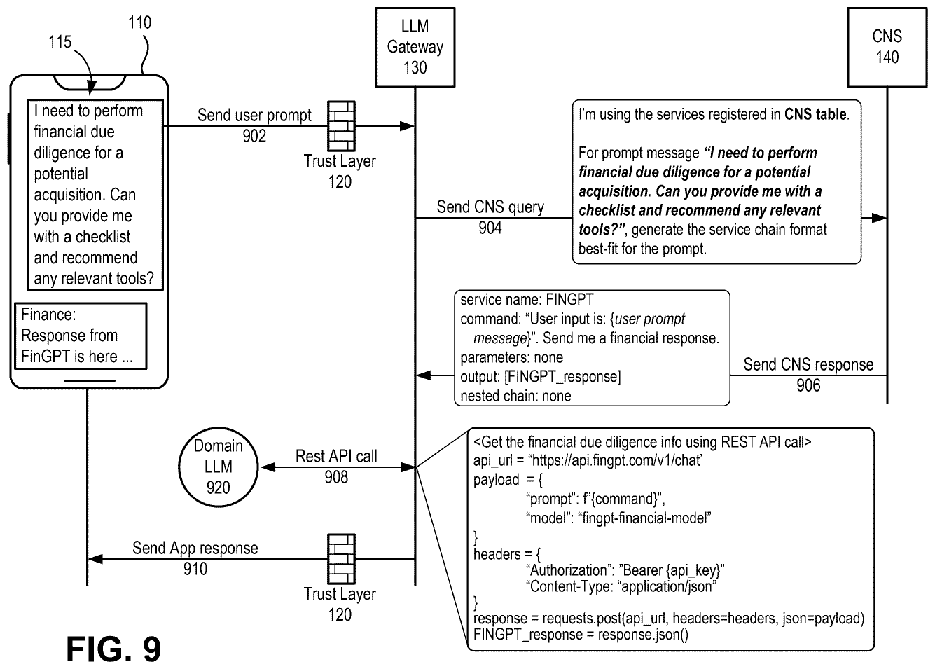

FIG. 9 illustrates a CNS simple query for a custom LLM service. As shown in FIG. 9, a user may input a prompt (“I need to perform financial due diligence for a potential acquisition. Can you provide me with a checklist and recommend any relevant tools?”) to client interface 115, and client device 110 may send a user prompt 902 via trust layer 120 to LLM gateway 130. LLM gateway 130 may generate a CNS query 904 and send the CNS query 904 to CNS server 140. CNS server 140 may receive CNS query 904 and generate a CNS response 906 including a sequent chain of services. CNS response 906 may be compiled based on the scope of access indicated in a customer CNS database for the user (e.g., database 650). CNS response 906 may include an appropriate service (“FINGPT”) with commands and parameters for generating a request. CNS server 140 may send, and LLM gateway 130 may receive, CNS response 906. LLM gateway 130 may provide to Domain LLM 920 an API call 908 (e.g., a REST API call) as defined in CNS response 906 and illustrated in FIG. 9. Domain LLM 920 may correspond, for example, to one of the applications in registered domain/custom LLM service 180. Upon receiving a response from domain LLM 920, LLM gateway 130 may forward the response 910 to client device 110 for presentation on client interface 115.

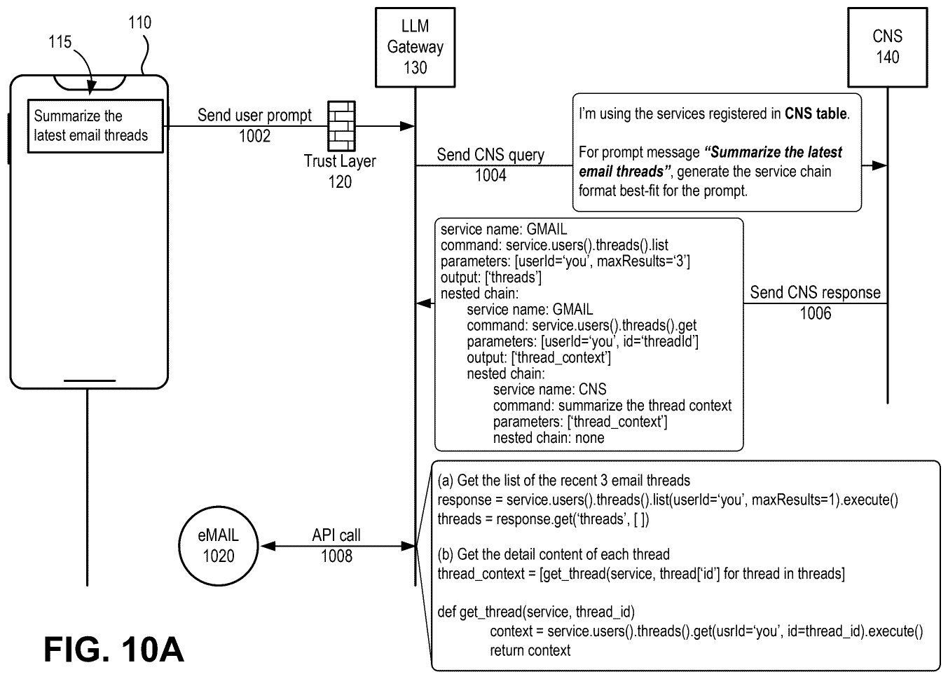

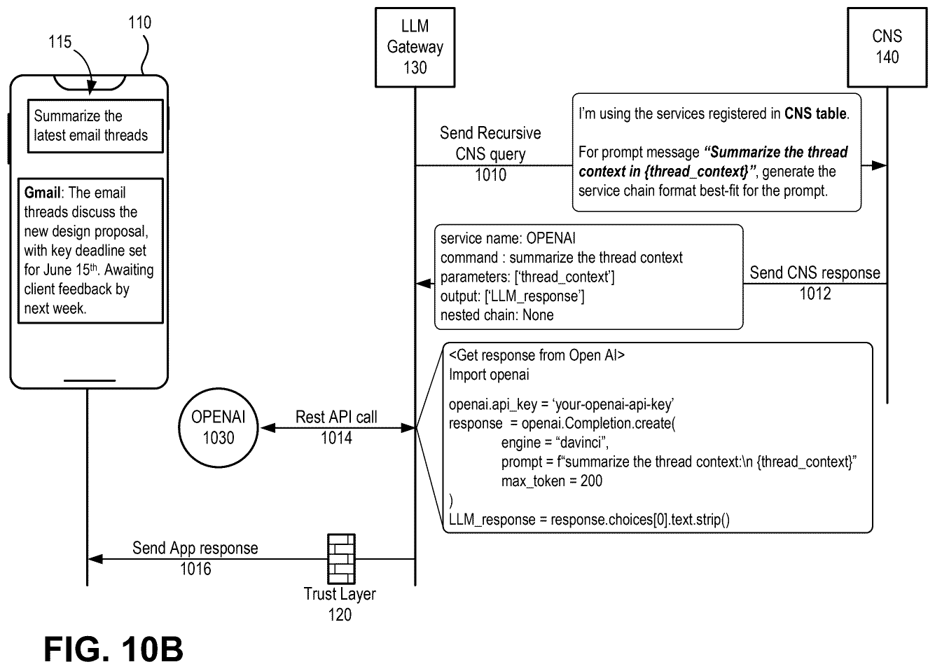

FIGS. 10A and 10B illustrate a CNS simple query for a custom LLM service. As shown in FIG. 10A, a user may input a prompt (“Summarize the latest email threads”) to client interface 115, and client device 110 may send a user prompt 1002 via trust layer 120 to LLM gateway 130. LLM gateway 130 may generate a CNS query 1004 and send the CNS query 1004 to CNS server 140. CNS server 140 may receive CNS query 1004 and generate a CNS response 1006 including a sequent chain of services. CNS response 1006 may be compiled based on the scope of access indicated in a customer CNS database for the user (e.g., database 650).

CNS response 1006 may include appropriate application services with multiple service chain links. A first service chain link may ask the user's email application (e.g., GMAIL) to identify, for example, what are the three most recent threads. A second service chain link may ask the user's email application to get the detailed content of each thread. A third service chain may direct a query back the CNS server to generate further instructions for summarizing the thread context. CNS server 140 may send, and LLM gateway 130 may receive, CNS response 1006. LLM gateway 130 may provide to email system 1020 an API call 1008 that is consistent with CNS response 1006, as illustrated in FIG. 10A. Email system 1020 may correspond, for example, to one of the applications in registered SaaS apps 160.

Referring to FIG. 10B, upon receiving a response from email system 1020 for the first two service chain links, LLM gateway 130 may send a recursive CNS query 1010 to CNS server 140 as directed in the third service chain link of CNS response 1006.

CNS server 140 may receive recursive CNS query 1010 and generate a CNS response 1012. Like previous responses, CNS response 1012 may be compiled based on the scope of access indicated in the customer CNS database for the user. CNS response 1012 may include an appropriate service (“OPENAI”) with commands and parameters for generating a request. CNS server 140 may send, and LLM gateway 130 may receive, CNS response 1012. LLM gateway 130 may provide to OPENAI service 1030 an API call 1014 (e.g., a REST API call) that is consistent with CNS response 1012, as illustrated in FIG. 10B. OPENAI service 1030 may correspond, for example, to one of the services in registered general LLM services 170. Upon receiving a response from OPENAI service 1030, LLM gateway 130 may forward the response 1016 to client device 110 for presentation on client interface 115 (e.g., “The email threads discuss the new design proposal, with key deadline set for June 15th. Awaiting client feedback by next week.”).

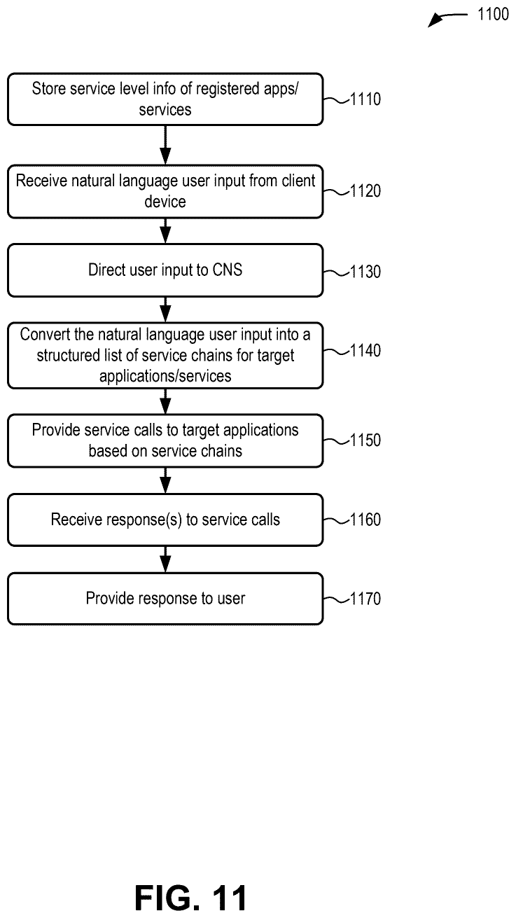

FIG. 11 is a flow diagram illustrating an exemplary process 1100 for providing a trustable chat name service, according to an implementation described herein. In one implementation, process 1100 may be implemented by CNS platform 230. In another implementation, process 1100 may be implemented by CNS platform 230 and client device 110. In still other implementations, process 1100 may be implemented by CNS platform 230 in conjunction with one or more other devices in environment 200. Some process blocks of FIG. 11 may be described in the context of components of FIGS. 4A and 4B.

Referring to FIG. 11, process 1100 may include storing service level information of registered AI services and customer access rights (block 1110). For example, CNS database 150 may store information for applications and services that register with CNS platform 230, such as various SaaS apps 160, general LLM services 170, and/or domain or custom LLM services 180. Stored information may include the app/service name, a corresponding unique ID, a domain category, a status, a vendor/provider, a service/application type, statistics on use and popularity, API formats/parameters, etc. CNS database 150 may also store records of user access rights to each of the registered apps/services.

Process 1100 may also include receiving natural language user input from a client device (block 1120) and designating the user input for a CNS (block 1130). For example, using client interface 115, a user (or initiator) may initiate a natural language query (e.g., user input message 402). The natural language query may not be designated for use with a particular AI system or application. Client device 110 may forward the user input to LLM gateway 130 via trust layer 120. Assuming trust layer authorizes the user/client device 110 for access, LLM gateway 130 may generate a CNS query (e.g., CNS query message 406, 804, 904, 1004). The CNS query may introduce the user input into the CNS server.

Process 1100 may further include converting the natural language user input into a structured list of service chains for target applications and/or services (block 1140). For example, CNS server 140 may receive a CNS query from LLM gateway 130. CNS server 140 may first interpret the context in the user input message and use CNS database 150 to identify target applications and/or LLM services. CNS server 140 may specify the relevant commands and parameters such as the target application's API call and parameter(s) or how to access LLM services. CNS server 140 may also indicate how to handle the outputs from the target applications and/or LLM services 160-180. CNS server 140 may formulate the information into a sequent chain of services and return a response (e.g., CNS response 410) to LLM gateway 130.

Process 1100 may additionally include providing service calls to the target applications based on service chains (block 1150), receiving one or more responses to service calls (block 1160), and providing the responses to the user (block 1170). For example, LLM gateway 130 may use the sequent chain of services from CNS server 140 to generate and provide calls (e.g., call 412) to the indicated target services (e.g., one or more services or applications from SaaS apps 160, general LLM services 170, and/or domain or custom LLM services 180). The respective services or applications may return responses (e.g., response 414) to LLM gateway 130, which may forward the responses (e.g., response 416) to client device 110 via trust layer 120. Client interface 115 of client device 110 may present the response to the user as a chat response.

Systems and methods described herein enable clients or users to chat with various AI-based applications and LLM services through a single user interface with assured privacy and security. A network device stores, in a memory, service level information of multiple external AI services. The network device receives a natural language request from a client device and directs a prompt message to a CNS system. The prompt message includes the natural language request. The network device converts the natural language request into a sequent chain of services to be performed by a target service of the multiple external AI services and send a service call to the target service based on the sequent chain of services. The network device forwards a response from the target service to the client device.

The foregoing description of embodiments provides illustration, but is not intended to be exhaustive or to limit the embodiments to the precise form disclosed. In the preceding description, various embodiments have been described with reference to the accompanying drawings. However, various modifications and changes may be made thereto, and additional embodiments may be implemented, without departing from the broader scope of the invention as set forth in the claims that follow. The description and drawings are accordingly to be regarded as illustrative rather than restrictive.

In addition, while series of communications and blocks have been described with regard to the processes illustrated in FIGS. 4A, 4B and 8-11, the order of the communications and blocks may be modified according to other embodiments. Further, non-dependent blocks may be performed in parallel. Additionally, other processes described in this description may be modified and/or non-dependent operations may be performed in parallel.

The embodiments described herein may be implemented in many different forms of software executed by hardware. For example, a process or a function may be implemented as “logic” or as a “component. ” The logic or the component may include, for example, hardware (e.g., processor 320, etc.), or a combination of hardware and software (e.g., software 335). The embodiments have been described without reference to the specific software code since the software code can be designed to implement the embodiments based on the description herein and commercially available software design environments/languages.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,”etc.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

The word “exemplary” is used herein to mean “serving as an example. ” Any embodiment or implementation described as “exemplary” is not necessarily to be construed as preferred or advantageous over other embodiments or implementations.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory storage medium that stores data and/or information, such as instructions, program code, data structures, program modules, an application, etc. The program code, instructions, application, etc., is readable and executable by a processor (e.g., processor 320) of a computational device. A non-transitory storage medium includes one or more of the storage mediums described in relation to memory 330.

To the extent the aforementioned embodiments collect, store or employ personal information provided by individuals, it should be understood that such information shall be used in accordance with all applicable laws concerning protection of personal information.

Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction described in the present application should be construed as critical or essential to the embodiments described herein unless explicitly described as such.

What is claimed IS:

1. A method comprising:
storing service level information of multiple external artificial intelligence (AI) services;
receiving, by one or more network devices, a natural language request from a client device;
directing, by the one or more network devices, a prompt message to a chat-name service (CNS) system, wherein the prompt message includes the natural language request;
converting, by the one or more network devices, the natural language request into at least one sequent chain of services to be performed by a target service of the multiple external AI services;
sending, by the one or more network devices, a service call to the target service based on the at least one sequent chain of services; and
forwarding, by the one or more network devices, a response from the target service to the client device.

2. The method of claim 1, wherein the converting includes:
performing a lookup of an authorization scope, for an initiator of the natural language request, to the multiple external AI services.

3. The method of claim 1, wherein the converting includes:
selecting the target service from the multiple external AI services.

4. The method of claim 1, wherein the converting includes:
forming a CNS response message in a concatenated format that includes a registered name of the target service, commands, and parameters for each link in the at least one sequent chain of services.

5. The method of claim 1, wherein sending the service call includes:
sending a first application programming interface (API) call to a first target service based on the at least one sequent chain of services; and
sending a second API call to a second target service based on the at least one sequent chain of services.

6. The method of claim 1, wherein the natural language request includes an authorization key for an initiator of the natural language request, and
wherein the authorization key is included with the prompt message.

7. The method of claim 1, wherein the multiple external AI services includes services provided by:
a software as a service (SaaS) application,
a general large language model (LLM) service, or
a domain-specific LLM service.

8. The method of claim 1, wherein the natural language request is service agnostic.

9. A system comprising:
one or more devices including processors configured to:
store service level information of multiple external artificial intelligence (AI) services;
receive a natural language request from a client device;
direct a prompt message to a chat-name service (CNS) system, wherein the prompt message includes the natural language request;
convert the natural language request into at least one sequent chain of services to be performed by a target service of the multiple external AI services;
send a service call to the target service based on the at least one sequent chain of services; and
forward a response from the target service to the client device.

10. The system of claim 9, wherein, when converting the natural language request, the processors are further configured to:
perform a lookup of an authorization scope, for an initiator of the natural language request, to the multiple external AI services.

11. The system of claim 9, wherein, when converting the natural language request, the processors are further configured to:
select the target service from the multiple external AI services.

12. The system of claim 9, wherein, when converting the natural language request, the processors are further configured to:
form a CNS response message in a concatenated format that includes a registered name of the target service, commands, and parameters for each link in the at least one sequent chain of services.

13. The system of claim 9, wherein, when sending the service call, the processors are further configured to:
send a first application programming interface (API) call to a first target service based on the at least one sequent chain of services; and
send, after sending the first API call, a second API call to a second target service based on the at least one sequent chain of services.

14. The system of claim 9, wherein the natural language request includes an authorization key for an initiator of the natural language request, and
wherein the authorization key is included with the prompt message.

15. The system of claim 9, wherein the multiple external AI services includes services provided by at least one of the following:
a software as a service (SaaS) application,
a general large language model (LLM) service, or
a domain-specific LLM service.

16. The system of claim 9, wherein the natural language request is service agnostic.

17. A non-transitory, computer-readable storage medium storing instructions executable by one or more processors of a computing device for:
storing service level information of multiple external artificial intelligence (AI) services;
receiving a natural language request from a client device;
directing a prompt message to a chat-name service (CNS) system, wherein the prompt message includes the natural language request;
converting the natural language request into at least one sequent chain of services to be performed by a target service of the multiple external AI services;
sending a service call to the target service based on the at least one sequent chain of services; and
forwarding a response from the target service to the client device.

18. The non-transitory, computer-readable storage medium of claim 17, wherein the instructions for converting the natural language request further include instructions for:
selecting the target service from the multiple external AI services, and
forming a CNS response message in a concatenated format that includes a registered name of the target service, commands, and parameters for each link in the at least one sequent chain of services.

19. The non-transitory, computer-readable storage medium of claim 17, wherein the instructions for sending the service call further include instructions for:
sending a first application programming interface (API) call to a first target service based on the at least one sequent chain of services; and
sending a second API call, after sending the first API call, to a second target service based on the at least one sequent chain of services.

20. The non-transitory, computer-readable storage medium of claim 17, wherein the natural language request is service agnostic.
